(19) United States
(12) Patent Application Publication
(10) Pub. No.: US 2021/0168822 A1
(43) Pub. Date: Jun. 3, 2021

(54) USER TERMINAL AND RADIO BASE STATION

(71) Applicant: NTT DOCOMO, INC., Tokyo (JP)

(72) Inventors: Daisuke Murayama, Tokyo (JP); Hiroki Harada, Tokyo (JP); Kazuaki Takeda, Tokyo (JP); Satoshi Nagata, Tokyo (JP)

(73) Assignee: NTT DOCOMO, INC., Tokyo (JP)

(21) Appl. No.: 17/048,867

(22) PCT Filed: Apr. 18, 2019
(86) PCT No.: PCT/JP2019/016701

§ 371 Date: Oct. 19, 2020

(30) Foreign Application Priority Data
Apr. 20, 2018 (JP) 2018-092586

(51) Int. Cl. H04W 72/08; H04W 74/02; H04W 72/04

(52) U.S. Cl. CPC H04W 72/085; H04W 72/0446; H04W 74/02

(57) ABSTRACT

A user terminal includes: a receiving section that receives at least one of a transmission request signal and a receivable signal according to a second radio communication standard in a carrier that applies listening to transmission of a first radio communication standard; and a control section that controls the listening based on a time parameter indicated in at least one of the transmission request signal and the receivable signal. According to an aspect of the present disclosure, it is possible to improve a collision avoidance rate of data transmitted according to a listening result.

### TECHNICAL FIELD

The present invention relates to a user terminal and a radio base station in next-generation mobile communication systems.

### BACKGROUND ART

In the UMTS (Universal Mobile Telecommunications System) network, the specifications of long-term evolution (LTE) have been drafted for the purpose of further increasing high speed data rates, providing lower delays and so on (see non-patent literature 1). In addition, successor systems of LTE are also under study for the purpose of achieving further broadbandization and increased speed beyond LTE (also referred to as “LTE-A (LTE-Advanced),” “FRA (Future Radio Access),” “4G,” “5G,” “5G+(plus),” “NR (New RAT),” “3GPP (3rd Generation Partnership Project) Rel. 14, 15, 16 or later versions” and so on).

In existing LTE systems (for example, Rel. 8 to 12), the specifications have been drafted assuming that exclusive operation is performed in a frequency band licensed to a telecommunications carrier (operator) (also referred to as a “licensed band,” a “licensed carrier,” a “licensed component carrier (CC)” and so on). As the licensed CC, for example, 800 MHz, 1.7 GHz, 2 GHz, etc. are used.

Further, in the existing LTE system (for example, Rel. 13), in order to extend the frequency band, a frequency band different from the above licensed band (also referred to as an “unlicensed band,” an “unlicensed carrier” or an “unlicensed CC”) is supported. As the unlicensed band, for example, 2.4 GHz band or 5 GHz band in which Wi-Fi (registered trademark) or Bluetooth (registered trademark) can be used is assumed.

Specifically, in Rel. 13, carrier aggregation (CA) that integrates a carrier (CC) in the licensed band and a carrier (CC) in the unlicensed band is supported. The communication performed using the unlicensed band together with the licensed band is called LAA (License-Assisted Access).

Regarding the use of LAA, the use of LAA is being considered also in future radio communication systems (for example, 5G, 5G+, NR, and Rel. 15 or later versions). In the future, it is possible that use of LAA will be considered also in dual connectivity (DC) between the licensed band and the unlicensed band and stand-alone (SA) of the unlicensed band.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

In the future LAA systems (for example, 5G, 5G+, NR, and Rel. 15 or later versions), the transmitting apparatus (for example, a radio base station in the downlink (DL), a user terminal in the uplink (UL)) performs listening (also referred to as “LBT (Listen Before Talk),” “CCA (Clear Channel Assessment),” “carrier sense,” “channel access procedure” and so on) for confirming the presence or absence of transmission of other pieces of apparatus (for example, radio base station, user terminal, Wi-Fi device and so on) before transmission of data in the unlicensed band.

Further, the transmitting apparatus starts data transmission after a given period (immediately or a backoff period) after it is detected that there is no transmission of other pieces of apparatus in the listening (idle state). It is also assumed that the transmitting apparatus transmits a signal using beamforming.

However, even when data is transmitted according to the result of listening (detection of idle state), there is a risk that data collision cannot be appropriately avoided. Moreover, if an appropriate beam is not used, there is a risk that throughput and communication quality may deteriorate.

The present invention has been made in view of the above, and it is therefore an object of the present invention to provide a user terminal and a radio base station capable of improving the avoidance rate of the collision of data transmitted according to the listening result.

### Solution to Problem

A user terminal according to an aspect of the present invention includes: a receiving section that receives at least one of a transmission request signal and a receivable signal according to a second radio communication standard in a carrier that applies listening to transmission of a first radio communication standard; and a control section that controls the listening based on a time parameter indicated in at least one of the transmission request signal and the receivable signal.

### Advantageous Effects of Invention

According to the present invention, it is possible to improve the collision avoidance rate of data transmitted according to the listening result.

### BRIEF DESCRIPTION OF DRAWINGS

FIG. 1 is a diagram to show an example of data collision by hidden terminals.

FIG. 2 is a diagram to show an example of CSMA/CA with RTS/CTS.

FIG. 3 is a diagram to show an example of RTS/CTS in a future LAA system.

FIG. 4 is a diagram to show an example of operation 1 of a transmitting apparatus.

FIG. 5 is a diagram to show an example of operation 2 of the transmitting apparatus.

FIG. 6A and FIG. 6B are diagrams to show an example of an RTS format.

FIG. 7A and FIG. 7B are diagrams to show an example of a CTS format.

FIG. 8 is a diagram to show an example of a schematic structure of a radio communication system according to the present embodiment.

FIG. 9 is a diagram to show an example of a functional structure of a radio base station according to the present embodiment.

FIG. 10 is a diagram to show an example of a functional configuration of a baseband signal processing section of the radio base station according to the present embodiment.

FIG. 11 is a diagram to show an example of a functional structure of a user terminal according to the present embodiment.

FIG. 12 is a diagram to show an example of a functional configuration of a baseband signal processing section of the user terminal according to the present embodiment.

FIG. 13 is a diagram to show an example of a hardware structure of the radio base station and the user terminal according to the present embodiment.

### DESCRIPTION OF EMBODIMENTS

In the unlicensed band (for example, 2.4 GHz band or 5 GHz band), it is assumed that a plurality of systems such as a Wi-Fi system and a system supporting LAA (LAA system) coexist. Therefore, it is necessary to avoid collision of transmissions and/or control interference between the plurality of systems.

For example, a Wi-Fi system using an unlicensed band employs CSMA (Carrier Sense Multiple Access)/CA (Collision Avoidance) for the purpose of collision avoidance and/or interference control. In CSMA/CA, a given time (DIFS (Distributed access Inter Frame Space)) is provided before transmission, and a transmitting apparatus transmits data after confirming that there is no other transmission signal (carrier sense). After transmitting the data, the transmitting apparatus waits for ACK (ACKnowledgement) from receiving apparatus. If the transmitting apparatus cannot receive the ACK within the given time, it is determined that a collision has occurred and performs retransmission.

In addition, in the Wi-Fi system, for the purpose of collision avoidance and/or interference control, RTS/CTS is employed in which a transmission request (RTS (Request to Send)) is transmitted before transmission, and if the receiving apparatus can receive it, it responds as being receivable (CTS (Clear to Send). For example, RTS/CTS is effective in avoiding data collisions due to hidden terminals.

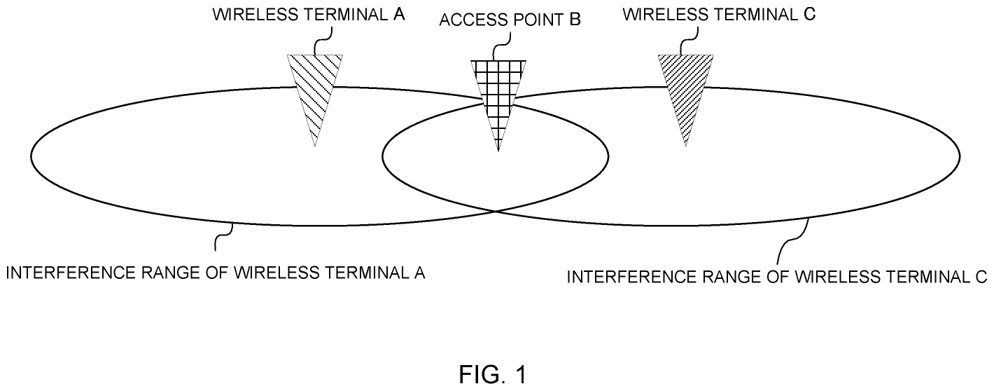

FIG. 1 is a diagram to show an example of data collision by hidden terminals. In FIG. 1, since a radio wave of a wireless terminal C does not reach a wireless terminal A, the wireless terminal A cannot detect a transmission signal from the wireless terminal C even if carrier sensing is performed before transmission. As a result, even if the wireless terminal B is being transmitted to an access point B, it is assumed that the wireless terminal A is also transmitted to the access point B. In this case, the transmission signals from the wireless terminals A and C collide at the access point B, which may reduce the throughput.

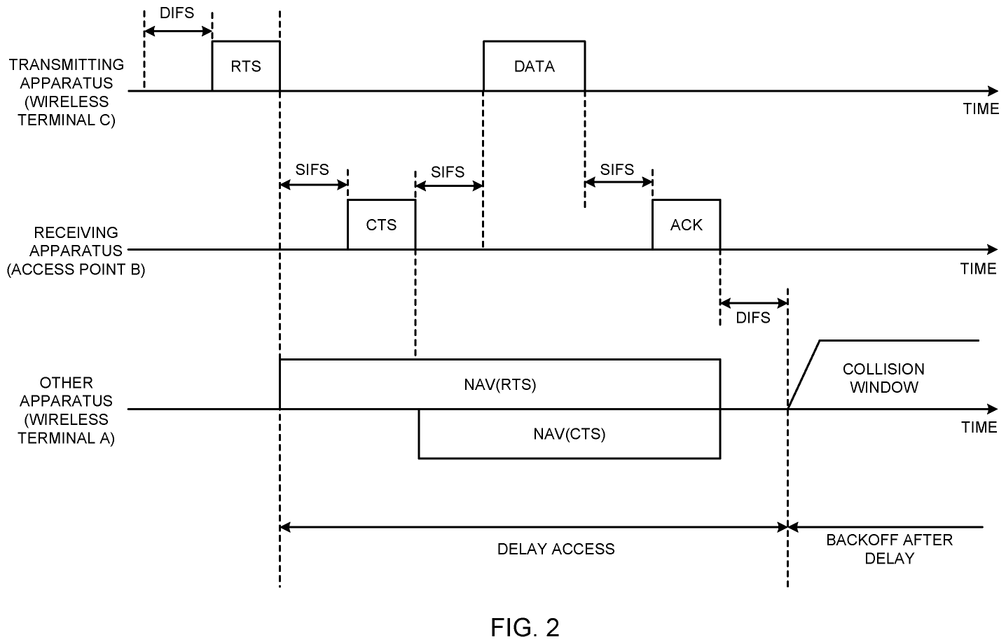

FIG. 2 is a diagram to show an example of CSMA/CA with RTS/CTS. As shown in FIG. 2, the wireless terminal C (transmission side) transmits RTS when it confirms that there is no other transmission signal in a given time (DIFS) before transmission (in FIG. 1, the RTS does not reach the wireless terminal A (other terminal)). Upon receiving the RTS from the wireless terminal C, the access point B (reception side) transmits CTS after a given time (SIFS (Short Inter Frame Space)).

In FIG. 2, the CTS from the access point B reaches the wireless terminal A (other pieces of apparatus), so that the wireless terminal A detects that communication is performed and delays the transmission. Since the RTS/CTS packet has a given period (also referred to as “NAV (Network Allocation Vector)” or “transmission prohibited period”) written therein, the communication is suspended during the given period.

Upon receiving the CTS from the access point B, the wireless terminal C confirms that there is no other transmission signal in the given period (SIFS) before transmission, and then transmits the data (frame) after the given period (SIFS). The access point B that receives the data transmits ACK after the given period (SIFS).

In FIG. 2, when the wireless terminal A, which is a hidden terminal of the wireless terminal C, detects the CTS from the access point B, the transmission is postponed, so that collision of the transmission signals of the wireless terminals A and C at the access point B can be avoided.

Incidentally, in LAA of the existing LTE system (for example, Rel. 13), data transmitting apparatus performs listening (also referred to as “LBT,” “CCA,” “carrier sense,” “channel access procedure” and so on) for confirming the presence or absence of transmission of other pieces of apparatus (for example, radio base station, user terminal, Wi-Fi device and so on) before transmission of data in the unlicensed band.

The transmitting apparatus may be, for example, a radio base station (for example, gNB (gNodeB)) in the downlink (DL) and a user terminal (for example, UE (User Equipment)) in the uplink (UL). Further, the receiving apparatus that receives data from the transmitting apparatus may be, for example, a user terminal in DL and a radio base station in UL.

In the LAA of the existing LTE system, the transmitting apparatus starts data transmission after a given period (for example, immediately or a backoff period) after it is detected that there is no transmission of other pieces of apparatus in the listening (idle state). However, even if the transmitting apparatus transmits data based on the result of the listening, as a result of the presence of the hidden terminal, there is a risk that data collision in the receiving apparatus may not be avoided.

Therefore, in the future LAA systems (also referred to as, for example, “Rel. 15 or later versions,” “5G,” “5G+,” “NR” and so on), in order to improve the avoidance rate of data collision in the receiving apparatus, supporting of the above RTS/CTS is being considered.

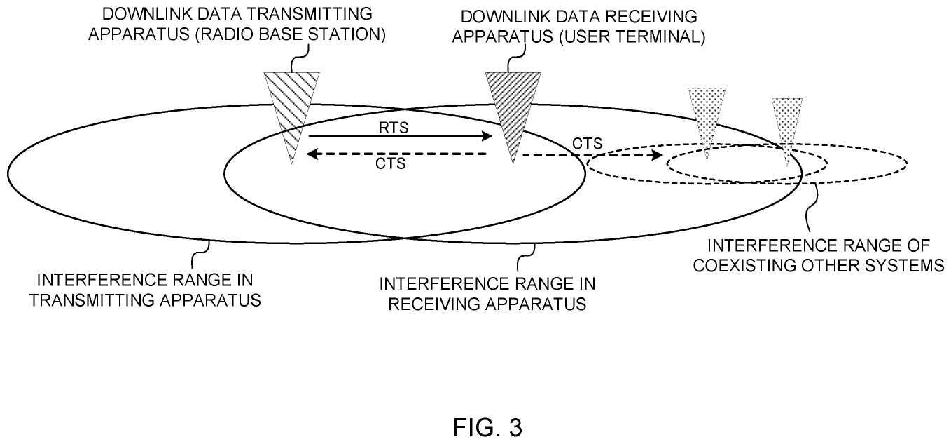

FIG. 3 is a diagram to show an example of RTS/CTS in a future LAA system. As shown in FIG. 3, in the future LAA system that supports RTS/CTS, it is assumed that the transmitting apparatus (radio base station) transmits RTS by an unlicensed band carrier (also referred to as an “unlicensed carrier,” “unlicensed CC,” “LAA SCell (Secondary Cell)” and so on) before transmitting the downlink data to the receiving apparatus (user terminal).

When, in the future LAA system, the upstream unlicensed CC is supported, it is conceivable that, as shown in FIG. 3, the downlink data receiving apparatus (user terminal) transmits CTS using the upstream unlicensed CC. An unlicensed CC of TDD (Time Division Duplex, unpaired spectrum) may be used instead of the upstream unlicensed CC.

Thus, when the LAA system supports RTS/CTS, there is a high possibility that the collision can be avoided, but there is a problem that the overhead for data becomes large.

Further, there is a risk that the CTS transmitted by the receiving apparatus may give unnecessarily interference (for example, detection of busy) to other pieces of apparatus (for example, other pieces of apparatus in the LAA system, or pieces of apparatus in coexisting other systems (for example, Wi-fi system)).

Therefore, the inventors of the present invention studied a method of suppressing interference by controlling transmission based on RTS and CTS, and arrived at the present invention.

Now, the present embodiment will be described below in detail with reference to the attached drawings. In the present embodiment, the unlicensed CC may be interpreted as a carrier in the first frequency band (cell, CC), a carrier in the unlicensed band (unlicensed spectrum) (cell, CC), LAA SCell, an LAA cell, a secondary cell (SCell), etc. Further, the licensed CC may be interpreted as a carrier of the second frequency band (cell, CC), a carrier of the licensed band (licensed spectrum) (cell, CC), a primary cell (PCell), SCell, etc.

Further, in the present embodiment, the unlicensed CC may be LTE-based or NR-based (NR unlicensed CC). Similarly, the licensed CC may be LTE-based or NR-based. In the LAA system (radio communication system) of the present embodiment, the unlicensed CC and the licensed CC may be subjected to carrier aggregation (CA) or dual connectivity (DC) in either the LTE or NR system (standalone), or may be subjected to CA or DC between LTE and NR systems (non-standalone).

RTS may be referred to as a “transmission request signal.” CTS may be referred to as a “receivable signal.”

The LAA system of the future may be referred to as an “NR-U (Unlicensed) system.” The LAA system may comply with (support) the first radio communication standard (for example, NR, LTE, etc.).

Other systems that coexist with this LAA system (coexistence system, coexistence apparatus) and other radio communication devices (coexistence apparatus) may comply with (support) a second radio communication standard, which is different from the first radio communication standard, such as Wi-Fi, Bluetooth, WiGig (registered trademark), wireless LAN (Local Area Network), IEEE802.11, etc. The coexistence system may be a system that receives interference from the LAA system or a system that gives interference to the LAA system. The coexistence system may support RTS and CTS, or equivalent transmission request signal and receivable signal.

### (Radio Communication Method)

The transmitting apparatus of the LAA system may receive and decrypt (decode) at least one of RTS and CTS transmitted by the coexistence apparatus (coexistence system) in the unlicensed CC. By this operation, the LAA system may acquire NAV from at least one of RTS and CTS and refrain from transmitting during the NAV period.

The transmitting apparatus may acquire NAV from at least one duration area of RTS and CTS. The LAA system (transmitting apparatus, receiving apparatus) may not transmit at least one of RTS and CTS.

The transmitting apparatus may perform at least one of the following operations 1 and 2.

### (Operation 1)

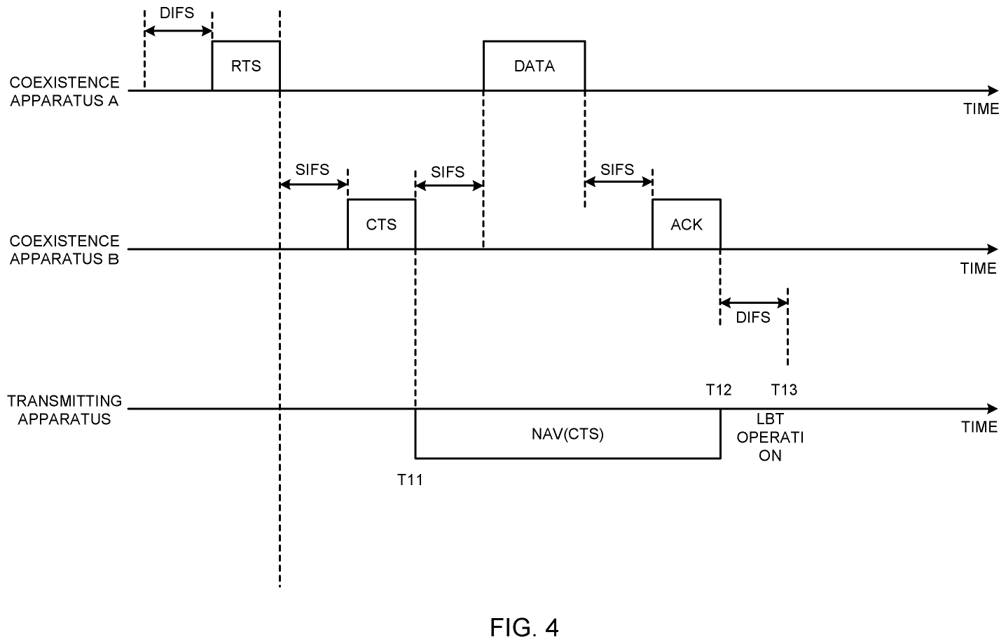

As shown in FIG. 4, when the transmitting apparatus receives CTS transmitted by coexistence apparatus B (T11), the transmitting apparatus may postpone the transmission and perform the LBT operation at a first timing (for example, T12, T13) based on NAV indicated in CTS. The first timing may be a time point at which a first time has elapsed from a CTS reception time (T11). The first time may be NAV of CTS (corresponding to T12) or NAV+DIFS of CTS (corresponding to T13).

The transmitting apparatus may perform data transmission when the transmission opportunity is obtained by the LBT operation (when the LBT result is idle). When the transmitting apparatus cannot obtain the transmission opportunity by the LBT operation, the transmitting apparatus may perform the LBT operation again.

### (Operation 2)

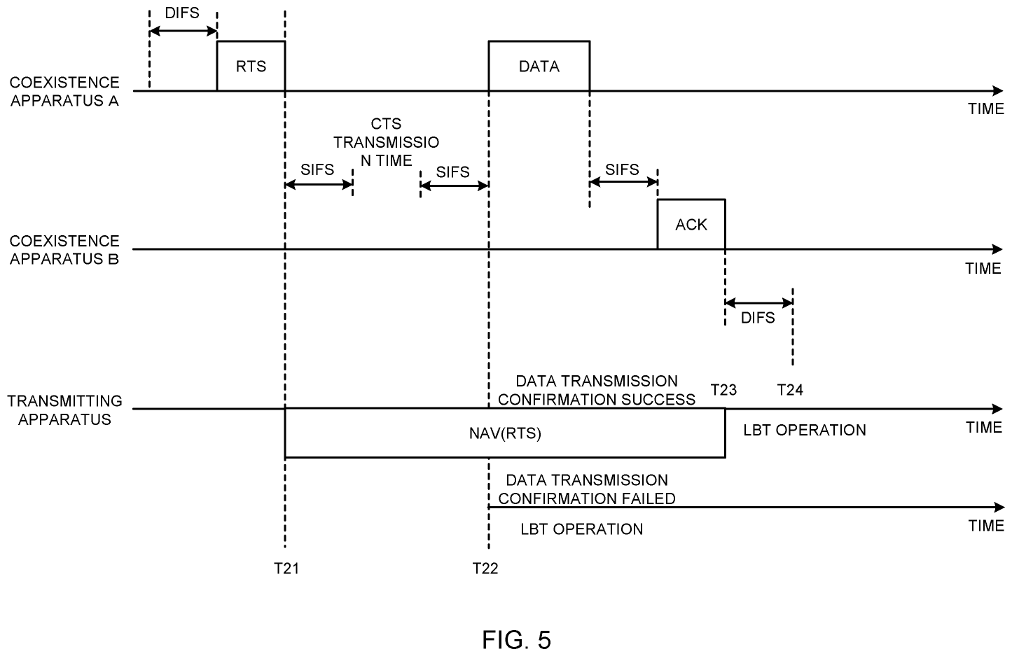

As shown in FIG. 5, when the transmitting apparatus receives RTS transmitted by apparatus A (T21), and does not receive CTS at the subsequent second timing (given period), the transmitting apparatus may confirm the transmission from coexistence apparatus A at the subsequent third timing (monitoring, listening). The second timing may be a period of a given time (CTS transmission time (time length of CTS)) from the elapse of a second time (for example, SIFS) from an RTS reception time point, or a part of the period. The third timing may be a time point (T22) at which a third time has elapsed from the RTS reception time point (T21). The third time may be SIFS+CTS transmission time (time length of CTS)+SIFS, or SIFS+CTS transmission time+SIFS+given margin. The transmitting apparatus may monitor the transmission of the coexistence apparatus A from the time point (T22) at which the standby time has elapsed until a given monitoring time has elapsed.

When the transmitting apparatus confirms the transmission from the coexistence apparatus A, the transmitting apparatus may perform the LBT operation at a fourth timing (for example, T23, T24) based on NAV shown in RTS. The fourth timing may be a time point at which a fourth time has elapsed from the time point at which RTS is received. The fourth time may be NAV of RTS (corresponding to T23) or NAV of RTS+given margin (corresponding to T24). The given margin may be DIFS. After that, the transmitting apparatus may perform data transmission when the transmission opportunity is obtained by the LBT operation.

When the transmitting apparatus cannot confirm the transmission from the coexistence apparatus A, the transmitting apparatus may perform the LBT operation at a fifth timing. The fifth timing may be immediately after it is decided that the transmission from the coexistence apparatus A cannot be confirmed (T22), or after a given time has elapsed from the determination. After that, the transmitting apparatus may perform data transmission when the transmission opportunity is obtained by the LBT operation.

According to this embodiment, it is possible to increase the avoidance rate of the signal collision with the coexistence apparatus which becomes the hidden terminal. By not transmitting CTS, the LAA system can prevent the interference due to CTS and improve the space-time utilization efficiency.

The transmitting apparatus only needs to be able to receive signal from the coexistence system (coexistence apparatus). The transmitting apparatus may have a radio interface (receiver, transceiver) for the coexistence system.

The radio interface for the coexistence system may be a radio interface for the LAA system. In this case, the transmitting apparatus may tune the radio interface for the LAA system to the radio interface for the coexistence system when it is necessary to receive the signal of the coexistence system.

The transmitting apparatus may have a radio interface for the coexistence system in addition to the radio interface for the LAA system. In this case, parameters such as the channel grid and subcarrier spacing used for the radio interface for the LAA system may be different from parameters of the coexistence system.

The monitoring of transmission of the coexistence apparatus may be carrier sensing or the like as in the LBT operation, or may be decoding of a part of the transmission signal.

### <RTS Format>

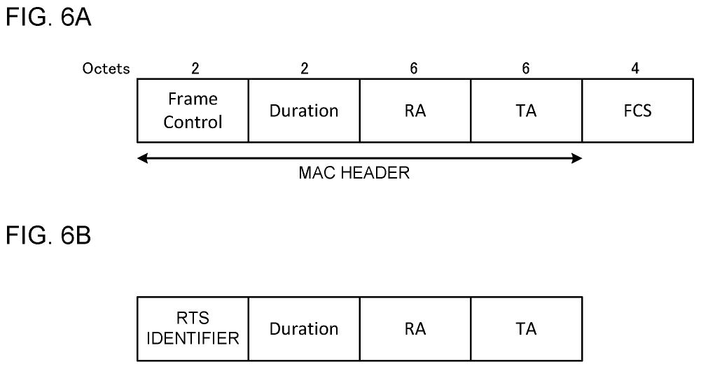

FIG. 6A and FIG. 6B are diagrams to show an example of an RTS format (also referred to as a “signal format,” a “frame format” and so on) received by the transmitting apparatus.

FIG. 6A shows an example of an RTS format (RTS format) that complies with the coexistence system (for example, IEEE 802.11). In FIG. 6A, the Duration area may indicate at least one of the time required for data transmission and the data amount (the number of octets).

Further, in the area storing the MAC (Medium Access Control) address on the receiving side (or the destination of the RTS) (RA (Receiver Address) area, destination field), UE ID (user terminal identifier) may be stored (may be included).

An identifier of a cell (cell ID) may be stored in an area storing the MAC address on the transmission side (TA (Transmitter Address) area) (or a transmission source of RTS). Further, TA may store identification information regarding a beam used for RTS (beam identification information, for example, beam number, beam identifier, or RTS identifier).

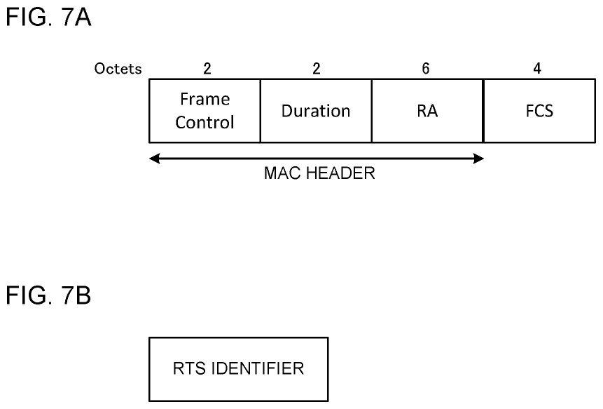

FIG. 6B shows another example of the RTS format. In the RTS format shown in FIG. 7B, the coexistence system may comply with a standard different from IEEE 802.11.

The RTS format shown in FIG. 6B may include at least one of an area indicating RTS (an area storing an identifier of RTS (RTS identifier)), an area indicating at least one of a time and a data amount required for data transmission (Duration area), an area for specifying a receiver (destination) (RA area), an area for specifying a sender (source) (TA area), and an area for specifying a beam (beam area).

In the RA area of FIG. 6B, the user terminal identifier (UE ID) may be stored (may be included).

### <CTS Format>

FIG. 7A and FIG. 7B are diagrams to show an example of a CTS format (also referred to as a “signal format,” a “frame format” and so on) received by the transmission signal.

FIG. 7A shows an example of an RTS response signal format (RTS response format, CTS format) that complies with the coexistence system (for example, IEEE 802.11). In FIG. 7A, the Duration area may indicate at least one of the time required for the data transmission and the data amount (the number of octets). In the RA area of FIG. 7A, the identifier of a user terminal (UE ID) may be stored. The RTS response signal format may further include FCS (Frame Check Sequence, for example, CRC (Cyclic Redundancy Check)). The RTS response signal format may further include information regarding the received beam (beam information). The beam information may be included in the RA area.

FIG. 7B shows another example of the RTS response format. In FIG. 7B, the coexistence system may comply with a standard other than IEEE 802.11. CTS may include at least one of an area indicating an RTS response signal (an area storing an identifier of RTS), and an area indicating beam information. The CTS format may further include an identifier of a user terminal (UE ID) of the transmission source.

Further, the CTS format may include the identifier of a user terminal (UE ID) of the transmission source of the RTS response signal.

### (Radio Communication System)

Now, the structure of a radio communication system according to the present embodiment will be described below. In this radio communication system, the radio communication method according to each of the above aspects is applied. Note that the radio communication methods according to the above aspects may be applied individually or in combination.

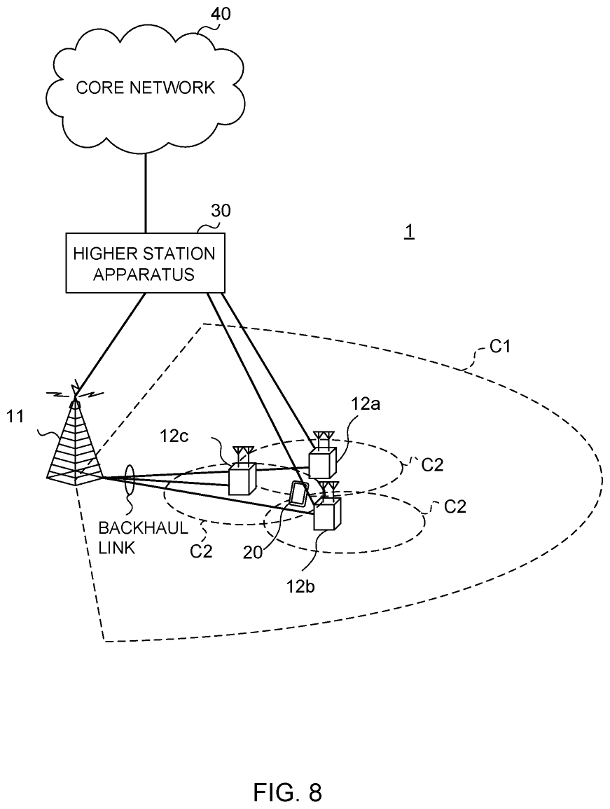

FIG. 8 is a diagram to show an example of a schematic structure of the radio communication system according to the present embodiment. A radio communication system 1 can adopt carrier aggregation (CA) and/or dual connectivity (DC) to group a plurality of fundamental frequency blocks (component carriers) into one, where the LTE system bandwidth (for example, 20 MHz) constitutes one unit. The radio communication system 1 may be referred to as “SUPER 3G,” “LTE-A (LTE-Advanced),” “IMT-Advanced,” “4G,” “5G,” “FRA (Future Radio Access),” “NR (New Rat)” and so on.

The radio communication system 1 shown in this figure includes a radio base station 11 that forms a macro cell C1, and radio base stations 12a to 12c that are placed within the macro cell C1 and that form small cells C2, which are narrower than the macro cell C1. Also, user terminals 20 are placed in the macro cell C1 and in each small cell C2. A configuration in which different neurologies are applied between cells may be adopted. Note that the numerology refers to a signal design in certain RAT or a set of communication parameters that characterize the RAT design.

The user terminals 20 can connect with both the radio base station 11 and the radio base stations 12. It is assumed that the user terminals 20 use the macro cell C1 and the small cells C2 that use different frequencies at the same time by CA or DC. Furthermore, the user terminals 20 can apply CA or DC using a plurality of cells (CCs) (for example, two or more CCs). Also, the user terminal can use the licensed band CC and the unlicensed band CC as a plurality of cells. In addition, it is possible to adopt a configuration in which a TDD carrier to which the shortened TTI is applied is included in any of the plurality of cells.

Between the user terminals 20 and the radio base station 11, communication can be carried out using a carrier of a relatively low frequency band (for example, 2 GHz) and a narrow bandwidth (referred to as an “existing carrier,” a “Legacy carrier” and so on). Meanwhile, between the user terminals 20 and the radio base stations 12, a carrier of a relatively high frequency band (for example, 3.5 GHz, 5 GHz, 30 to 70 GHz and so on) and a wide bandwidth may be used, or the same carrier as that used in the radio base station 11 may be used. Note that the structure of the frequency band for use in each radio base station is by no means limited to these.

A structure can be employed here in which wire connection (for example, means in compliance with CPRI (Common Public Radio Interface) such as optical fiber, the X2 interface and so on) or wireless connection is established between the radio base station 11 and the radio base station 12 (or between two radio base stations 12).

The radio base station 11 and the radio base stations 12 are each connected with higher station apparatus 30, and are connected with a core network 40 via the higher station apparatus 30. Note that the higher station apparatus 30 may be, for example, access gateway apparatus, a radio network controller (RNC), a mobility management entity (MME) and so on, but is by no means limited to these. Also, each radio base station 12 may be connected with the higher station apparatus 30 via the radio base station 11.

Note that the radio base station 11 is a radio base station having a relatively wide coverage, and may be referred to as a “macro base station,” a “central node,” an “eNB (eNodeB),” a “transmission/reception point” and so on. Also, the radio base stations 12 are radio base stations having local coverages, and may be referred to as “small base stations,” “micro base stations,” “pico base stations,” “femto base stations,” “HeNBs (Home eNodeBs),” “RRHs (Remote Radio Heads),” “transmission/reception points” and so on. Hereinafter the radio base stations 11 and 12 will be collectively referred to as “radio base stations 10,” unless specified otherwise.

The user terminals 20 are terminals to support various communication schemes such as LTE, LTE-A, NR, 5G, 5G+and so on, and may be either mobile communication terminals or stationary communication terminals.

In the radio communication system 1, as radio access schemes, OFDMA (Orthogonal Frequency Division Multiple Access) can be applied to the downlink (DL), and SC-FDMA (Single Carrier-Frequency Division Multiple Access) can be applied to the uplink (UL). OFDMA is a multi-carrier communication scheme to perform communication by dividing a frequency bandwidth into a plurality of narrow frequency bandwidths (subcarriers) and mapping data to each subcarrier. SC-FDMA is a single-carrier communication scheme to mitigate interference between terminals by dividing the system bandwidth into bands formed with one or continuous resource blocks per terminal, and allowing a plurality of terminals to use mutually different bands. Note that the uplink and downlink radio access schemes are not limited to the combinations of these, and OFDMA may be used in UL.

In the radio communication system 1, a downlink data channel (PDSCH (Physical Downlink Shared Channel), which is also referred to as a “downlink shared channel” and so on), which is used by each user terminal 20 on a shared basis, a broadcast channel (PBCH (Physical Broadcast Channel)), L1/L2 control channels and so on are used as a DL channel. User data, higher layer control information and SIB (System Information Block) are communicated in the PDSCH. Also, the MIB (Master Information Block) is communicated in the PBCH.

The L1/L2 control channels include a downlink control channel (PDCCH (Physical Downlink Control Channel), EPDCCH (Enhanced Physical Downlink Control Channel)), PCFICH (Physical Control Format Indicator Channel), PHICH (Physical Hybrid-ARQ Indicator Channel) and so on. Downlink control information (DCI), including PDSCH and PUSCH scheduling information and so on, is communicated by the PDCCH. The number of OFDM symbols to use for the PDCCH is communicated by the PCFICH. Delivery acknowledgment information (ACK/NACK) of HARQ to PUSCH is communicated by the PHICH. The EPDCCH is frequency-division-multiplexed with the PDSCH (downlink shared data channel) and used to communicate DCI and so on, like the PDCCH.

In the radio communication system 1, an uplink data channel (PUSCH (Physical Uplink Shared Channel), which is also referred to as an “uplink shared channel” and so on), which is used by each user terminal 20 on a shared basis, an uplink control channel (PUCCH (Physical Uplink Control Channel)), a random access channel (PRACH (Physical Random Access Channel)) and so on are used as UL channels. User data and higher layer control information are communicated by the PUSCH. Uplink control information (UCI (Uplink Control Information), including at least one of delivery acknowledgment information (ACK/NACK) and radio quality information (CQI), is communicated by the PUSCH or the PUCCH. Random access preambles for establishing connections with cells are communicated by the PRACH.

### <Radio Base Station>

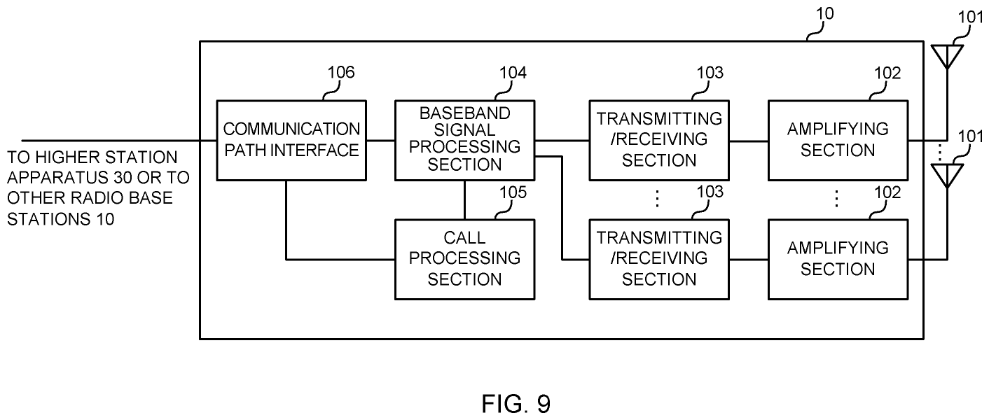

FIG. 9 is a diagram to show an example of an overall structure of the radio base station according to the present embodiment. The radio base station 10 includes a plurality of transmitting/receiving antennas 101, amplifying sections 102 and transmitting/receiving sections 103, a baseband signal processing section 104, a call processing section 105 and a communication path interface 106. Note that one or more transmitting/receiving antennas 101, amplifying sections 102 and transmitting/receiving sections 103 may be provided. The radio base station 10 is downlink data transmitting apparatus and may be uplink data receiving apparatus.

Downlink data to be transmitted from the radio base station 10 to the user terminal 20 is input from the higher station apparatus 30 to the baseband signal processing section 104, via the communication path interface 106.

In the baseband signal processing section 104, the downlink data is subjected to transmission processes, including a PDCP (Packet Data Convergence Protocol) layer process, division and coupling of the user data, RLC (Radio Link Control) layer transmission processes such as RLC retransmission control, MAC (Medium Access Control) retransmission control (for example, an HARQ transmission process), scheduling, transport format selection, channel coding, an inverse fast Fourier transform (IFFT) process and a precoding process, and the result is forwarded to the transmitting/receiving sections 103. Furthermore, downlink control signals are also subjected to transmission processes such as channel coding and an inverse fast Fourier transform, and forwarded to the transmitting/receiving sections 103.

Baseband signals that are pre-coded and output from the baseband signal processing section 104 on a per antenna basis are converted into a radio frequency band in the transmitting/receiving sections 103, and then transmitted. The radio frequency signals having been subjected to frequency conversion in the transmitting/receiving sections 103 are amplified in the amplifying sections 102, and transmitted from the transmitting/receiving antennas 101. The transmitting/receiving sections 103 can be constituted by transmitters/receivers, transmitting/receiving circuits or transmitting/receiving apparatus that can be described based on general understanding of the technical field to which the present invention pertains. Note that the transmitting/receiving section 103 may be structured as a transmitting/receiving section in one entity, or may be constituted by a transmitting section and a receiving section.

Meanwhile, as for uplink signals, radio frequency signals that are received in the transmitting/receiving antennas 101 are each amplified in the amplifying sections 102. The transmitting/receiving sections 103 receive the uplink signals amplified in the amplifying sections 102. The received signals are converted into the baseband signal through frequency conversion in the transmitting/receiving sections 103 and output to the baseband signal processing section 104.

In the baseband signal processing section 104, user data that is included in the uplink signals that are input is subjected to a fast Fourier transform (FFT) process, an inverse discrete Fourier transform (IDFT) process, error correction decoding, a MAC retransmission control receiving process, and RLC layer and PDCP layer receiving processes, and forwarded to the higher station apparatus 30 via the communication path interface 106. The call processing section 105 performs call processing such as setting up and releasing of communication channels, manages the state of the radio base stations 10 and manages the radio resources.

The communication path interface 106 transmits and receives signals to and from the higher station apparatus 30 via a given interface. Also, the communication path interface 106 may transmit and receive signals (backhaul signaling) with other radio base stations 10 via an inter-base station interface (for example, optical fiber that is in compliance with CPRI (Common Public Radio Interface) or the X2 interface).

The transmitting/receiving sections 103 transmit downlink signals (for example, downlink control signals (downlink control channels), downlink data signals (downlink data channels, downlink shared channels), downlink reference signals (DM-RS, CSI-RS, etc.), discovery signals, synchronization signals, broadcast signals, etc.), and receive uplink signals (for example, uplink control signals (uplink control channels), uplink data signals (uplink data channels, uplink shared channels), uplink reference signals, etc.).

Further, the transmitting/receiving sections 103 may receive, in the carrier (for example, the unlicensed CC) that applies listening to transmission of the first radio communication standard (for example, NR, LTE, etc.), at least one of a transmission request signal (for example, RTS) and a receivable signal (for example, CTS) according to the second radio communication standard (for example, WiFi, WiGig, wireless LAN, etc.).

The transmitting section and the receiving section of the present invention are constituted by the transmitting/receiving section 103 and/or the communication path interface 106.

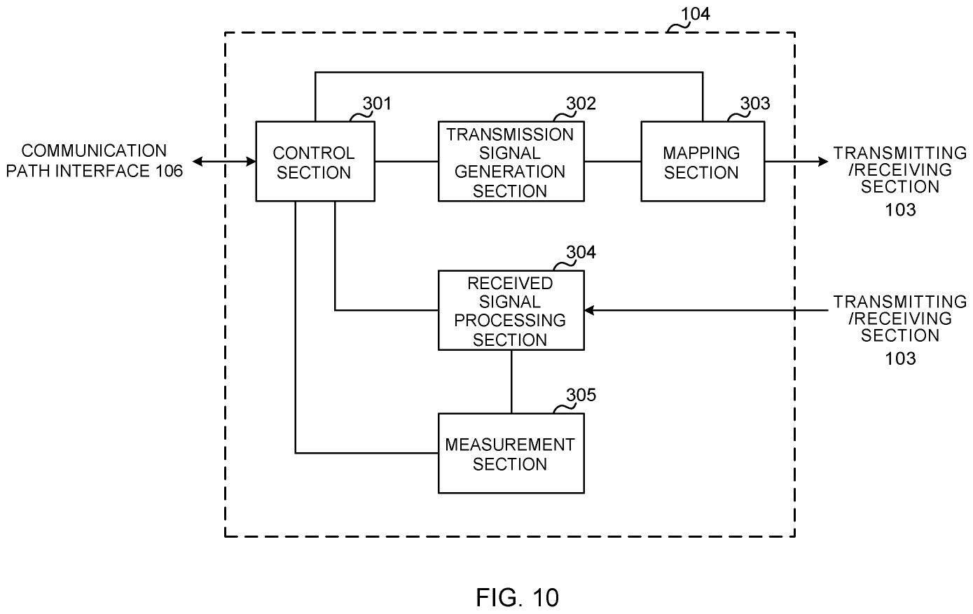

FIG. 10 is a diagram to show an example of a functional structure of the radio base station according to the present embodiment. Note that, although this figure will primarily show functional blocks that pertain to characteristic parts of the present embodiment, the radio base station 10 has other functional blocks that are necessary for radio communication as well. As shown in this figure, the baseband signal processing section 104 at least includes a control section 301, a transmission signal generation section 302, a mapping section 303, a received signal processing section 304 and a measurement section 305.

The control section 301 controls the whole of the radio base station 10. The control section 301 can be constituted by a controller, a control circuit or control apparatus that can be described based on general understanding of the technical field to which the present invention pertains.

The control section 301, for example, controls the generation of signals in the transmission signal generation section 302, and the allocation of signals by the mapping section 303. Furthermore, the control section 301 controls the signal receiving processes in the received signal processing section 304, and the measurements of signals in the measurement section 305.

The control section 301 controls scheduling (for example, resource allocation) of downlink signals and/or uplink signals. Specifically, the control section 301 controls the transmission signal generation section 302, the mapping section 303, and the transmitting/receiving sections 103 so as to generate and transmit DCI including scheduling information of downlink data channels (DL assignment, DL grant), and DCI including scheduling information of uplink data channel (UL grant).

Further, the control section 301 may control the listening based on a time parameter (for example, NAV) indicated in at least one of the transmission request signal and the receivable signal.

When the transmitting/receiving section 103 receives the receivable signal, the control section 301 may control the listening after the elapse of time based on the time parameter (first time) from the reception of the receivable signal (first timing).

When the transmitting/receiving section 203 does not receive the receivable signal in a given period after the reception of the transmission request signal (second timing), the control section 301 may control the listening based on monitoring of the transmission signal from the transmission source of the transmission request signal.

Further, when the transmission signal is detected by the monitoring, the control section 301 may control the listening after the elapse of time based on the time parameter (fourth time) from the reception of the transmission request signal (fourth timing).

Further, when the transmission signal is not detected by the monitoring, the control section 301 may control the listening immediately (fifth timing).

The transmission signal generation section 302 generates downlink signals (downlink control channels, downlink data channels, downlink reference signals such as DM-RS and so on) based on commands from the control section 301, and outputs these signals to the mapping section 303. The transmission signal generation section 302 can be constituted by a signal generator, a signal generating circuit or signal generation apparatus that can be described based on general understanding of the technical field to which the present invention pertains.

The mapping section 303 maps the downlink signals generated in the transmission signal generation section 302 to given radio resources based on commands from the control section 301, and outputs these to the transmitting/receiving sections 103. The mapping section 303 can be constituted by a mapper, a mapping circuit or mapping apparatus that can be described based on general understanding of the technical field to which the present invention pertains.

The received signal processing section 304 performs receiving processes (for example, demapping, demodulation, decoding and so on) of received signals that are input from the transmitting/receiving sections 103. Here, the received signals include, for example, uplink signals transmitted from the user terminals 20 (uplink control channels, uplink data channels, uplink reference signals, etc.). For the received signal processing section 304, a signal processor, a signal processing circuit or signal processing apparatus that can be described based on general understanding of the technical field to which the present invention pertains can be used.

The received signal processing section 304 outputs the information decoded by the receiving processes to the control section 301. For example, the received signal processing section 304 outputs at least one of the preamble, control information, and the uplink data to the control section 301. Also, the received signal processing section 304 outputs the received signals or the signals after the receiving processes to the measurement section 305.

The measurement section 305 conducts measurements with respect to the received signals. The measurement section 305 can be constituted by a measurer, a measurement circuit or measurement apparatus that can be described based on general understanding of the technical field to which the present invention pertains.

The measurement section 305 may measure, for example, the reception power (for example, RSRP (Reference Signal Received Power)) of the received signal, the reception quality (for example, RSRQ (Reference Signal Received Quality)), the channel state and so on. The measurement results may be output to the control section 301.

### (User Terminal)

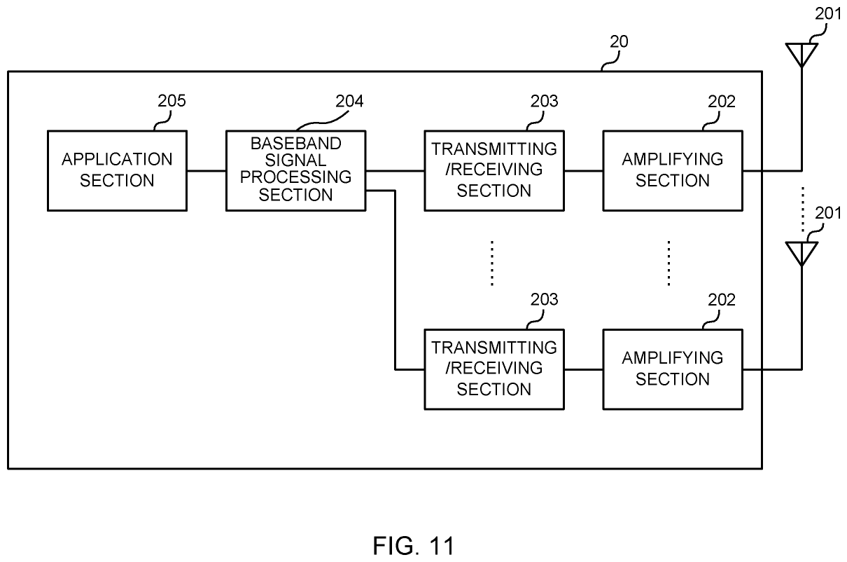

FIG. 11 is a diagram to show an example of an overall structure of the user terminal according to the present embodiment. The user terminal 20 includes a plurality of transmitting/receiving antennas 201, amplifying sections 202 and transmitting/receiving sections 203, a baseband signal processing section 204 and an application section 205. Note that one or more transmitting/receiving antennas 201, amplifying sections 202 and transmitting/receiving sections 203 may be provided. The user terminal 20 is downlink data receiving apparatus and may be uplink data transmitting apparatus.

Radio frequency signals that are received in the transmitting/receiving antennas 201 are amplified in the amplifying sections 202. The transmitting/receiving sections 203 receive the downlink signals amplified in the amplifying sections 202. The received signals are subjected to frequency conversion and converted into the baseband signal in the transmitting/receiving sections 203, and output to the baseband signal processing section 204. The transmitting/receiving sections 203 can be constituted by transmitters/receivers, transmitting/receiving circuits or transmitting/receiving apparatus that can be described based on general understanding of the technical field to which the present invention pertains. Note that the transmitting/receiving section 203 may be structured as a transmitting/receiving section in one entity, or may be constituted by a transmitting section and a receiving section.

The baseband signal processing section 204 performs receiving processes for the baseband signal that is input, including an FFT process, error correction decoding, retransmission control and so on. The downlink data is forwarded to the application section 205. The application section 205 performs processes related to higher layers above the physical layer and the MAC layer and so on. Further, the system information and the higher layer control information in the downlink data are also forwarded to the application section 205.

Meanwhile, uplink data is input from the application section 205 to the baseband signal processing section 204. The baseband signal processing section 204 performs a retransmission control transmission process (for example, an HARQ transmission process), channel coding, precoding, a discrete Fourier transform (DFT) process, an IFFT process and so on, and the result is forwarded to the transmitting/receiving section 203. Baseband signals that are output from the baseband signal processing section 204 are converted into a radio frequency band in the transmitting/receiving sections 203 and transmitted. The radio frequency signals that are subjected to frequency conversion in the transmitting/receiving sections 203 are amplified in the amplifying sections 202, and transmitted from the transmitting/receiving antennas 201.

The transmitting/receiving sections 203 receive downlink signals (for example, downlink control signals (downlink control channels), downlink data signals (downlink data channels, downlink shared channels), downlink reference signals (DM-RS, CSI-RS, etc.), discovery signals, synchronization signals, broadcast signals, etc.), and transmit uplink signals (for example, uplink control signals (uplink control channels), uplink data signals (uplink data channels, uplink shared channels), uplink reference signals, etc.).

Further, the transmitting/receiving sections 203 may receive, in the carrier (for example, the unlicensed CC) that applies listening to transmission of the first radio communication standard (for example, NR, LTE, etc.), at least one of a transmission request signal (for example, RTS) and a receivable signal (for example, CTS) according to the second radio communication standard (for example, WiFi, WiGig, wireless LAN, etc.).

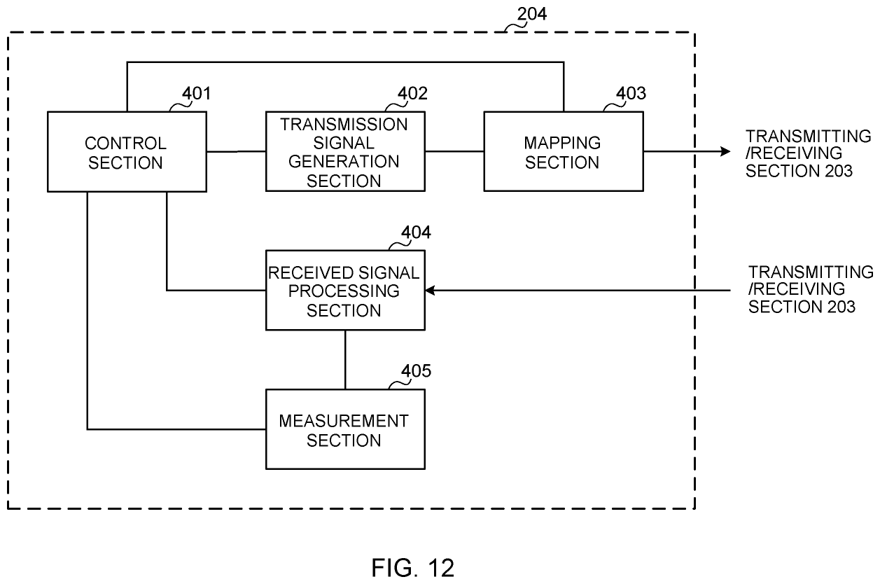

FIG. 12 is a diagram to show an example of a functional structure of the user terminal according to the present embodiment. Note that, although this figure will primarily show functional blocks that pertain to characteristic parts of the present embodiment, the user terminal 20 has other functional blocks that are necessary for radio communication as well. As shown in this figure, the baseband signal processing section 204 provided in the user terminal 20 at least includes a control section 401, a transmission signal generation section 402, a mapping section 403, a received signal processing section 404 and a measurement section 405.

The control section 401 controls the whole of the user terminal 20. The control section 401 can be constituted by a controller, a control circuit or control apparatus that can be described based on general understanding of the technical field to which the present invention pertains.

The control section 401, for example, controls the generation of signals in the transmission signal generation section 402, and the allocation of signals by the mapping section 403. Furthermore, the control section 401 controls the signal receiving processes in the received signal processing section 404, and the measurements of signals in the measurement section 405.

Further, the control section 401 may control the listening based on a time parameter (for example, NAV) indicated in at least one of the transmission request signal and the receivable signal.

When the transmitting/receiving section 203 receives the receivable signal, the control section 401 may control the listening after the elapse of time based on the time parameter (first time) from the reception of the receivable signal (first timing).

When the transmitting/receiving section 203 does not receive the receivable signal in a given period after the reception of the transmission request signal (second timing), the control section 401 may control the listening based on monitoring of the transmission signal from the transmission source of the transmission request signal.

Further, when the transmission signal is detected by the monitoring, the control section 401 may control the listening after the elapse of time based on the time parameter (fourth time) from the reception of the transmission request signal (fourth timing).

Further, when the transmission signal is not detected by the monitoring, the control section 401 may control the listening immediately (fifth timing).

The transmission signal generation section 402 generates uplink signals (uplink control channels, uplink data channels, uplink reference signals, etc.) based on commands from the control section 401, and outputs these signals to the mapping section 403. The transmission signal generation section 402 can be constituted by a signal generator, a signal generating circuit or signal generating apparatus that can be described based on general understanding of the technical field to which the present invention pertains.

The transmission signal generation section 402 generates uplink data channels based on commands from the control section 401. For example, when a UL grant is included in a downlink control channel that is reported from the radio base station 10, the control section 401 commands the transmission signal generation section 402 to generate an uplink data channel.

The mapping section 403 maps the uplink signals generated in the transmission signal generation section 402 to radio resources based on commands from the control section 401, and outputs the result to the transmitting/receiving section 203. The mapping section 403 can be constituted by a mapper, a mapping circuit or mapping apparatus that can be described based on general understanding of the technical field to which the present invention pertains.

The received signal processing section 404 performs receiving processes (for example, demapping, demodulation, decoding and so on) of received signals that are input from the transmitting/receiving sections 203. Here, the received signals include, for example, downlink signals (downlink control channels, downlink data channels, downlink reference signals, etc.) that are transmitted from the radio base station 10. The received signal processing section 404 can be constituted by a signal processor, a signal processing circuit or signal processing apparatus that can be described based on general understanding of the technical field to which the present invention pertains. Also, the received signal processing section 404 can constitute the receiving section according to the present invention.

The received signal processing section 404 blind-decodes the downlink control channels that schedule at least one of the transmission and reception of the downlink data channels based on commands from the control section 401, and performs the receiving processes of the downlink data channels based on the DCI. Also, the received signal processing section 404 estimates the channel gain based on DM-RS or CRS, and demodulates the downlink data channels based on the estimated channel gain.

The received signal processing section 404 outputs the information decoded by the receiving processes to the control section 401. The received signal processing section 404 outputs, for example, broadcast information, system information, RRC signaling, DCI and so on, to the control section 401. The received signal processing section 404 may output the data decoding result to the control section 401. Also, the received signal processing section 404 outputs the received signals or the signals after the receiving processes to the measurement section 405.

The measurement section 405 conducts measurements with respect to the received signals. The measurement section 405 can be constituted by a measurer, a measurement circuit or measurement apparatus that can be described based on general understanding of the technical field to which the present invention pertains.

The measurement section 405 may measure, for example, the reception power (for example, RSRP) of the received signal, the DL reception quality (for example, RSRQ), the channel state and so on. The measurement results may be output to the control section 401.

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be implemented by one piece of apparatus that is physically or logically aggregated, or may be implemented by directly or indirectly connecting two or more physically or logically separate pieces of apparatus (for example, via wire, wireless, etc.) and using these multiple pieces of apparatus.

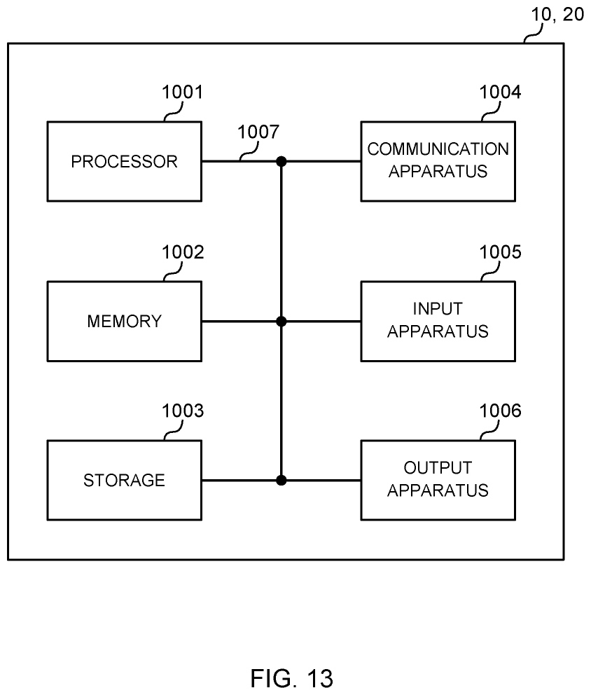

For example, the radio base station, user terminals and so on according to one present embodiment of the present disclosure may function as a computer that executes the processes of the radio communication method of the present disclosure. FIG. 13 is a diagram to show an example of a hardware structure of the radio base station and the user terminal according to one embodiment. Physically, the above-described radio base stations 10 and user terminals 20 may be formed as a computer apparatus that includes a processor 1001, a memory 1002, a storage 1003, communication apparatus 1004, input apparatus 1005, output apparatus 1006 and a bus 1007.

Note that, in the following description, the word “apparatus” may be replaced by “circuit,” “device,” “unit” and so on. Note that the hardware structure of the radio base station 10 and the user terminal 20 may be designed to include one or more of each apparatus shown in the drawings, or may be designed not to include part of the apparatus.

For example, although only one processor 1001 is shown, a plurality of processors may be provided. Furthermore, processes may be executed by one processor, or processes may be executed simultaneously, in sequence, or in different manners by one or more processors. Note that the processor 1001 may be implemented with one or more chips.

Each function of the radio base station 10 and the user terminal 20 is implemented by reading given software (program) on hardware such as the processor 1001 and the memory 1002 so that the processor 1001 performs computation, the communication in the communication apparatus 1004 is controlled, and at least one of the reading and writing of data in the memory 1002 and the storage 1003 is controlled.

The processor 1001 controls the whole computer by, for example, running an operating system. The processor 1001 may be configured with a central processing unit (CPU), which includes interfaces with peripheral apparatus, control apparatus, computing apparatus, a register and so on. For example, the above-described baseband signal processing section 104 (204), call processing section 105 and so on may be implemented by the processor 1001.

Furthermore, the processor 1001 reads programs (program codes), software modules or data, from at least one of the storage 1003 and the communication apparatus 1004, into the memory 1002, and executes various processes according to these. As for the programs, programs to allow computers to execute at least part of the operations of the above-described embodiments may be used. For example, the control section 401 of the user terminals 20 may be implemented by control programs that are stored in the memory 1002 and that operate on the processor 1001, and other functional blocks may be implemented likewise.

The memory 1002 is a computer-readable recording medium, and may be constituted by, for example, at least one of a ROM (Read Only Memory), an EPROM (Erasable Programmable ROM), an EEPROM (Electrically EPROM), a RAM (Random Access Memory) and/or other appropriate storage media. The memory 1002 may be referred to as a “register,” a “cache,” a “main memory (primary storage apparatus)” and so on. The memory 1002 can store executable programs (program codes), software modules and/or the like for implementing the radio communication methods according to one embodiment of the present disclosure.

The storage 1003 is a computer-readable recording medium, and may be constituted by, for example, at least one of a flexible disk, a floppy (registered trademark) disk, a magneto-optical disk (for example, a compact disc (CD-ROM (Compact Disc ROM) and so on), a digital versatile disc, a Blu-ray (registered trademark) disk), a removable disk, a hard disk drive, a smart card, a flash memory device (for example, a card, a stick, a key drive, etc.), a magnetic stripe, a database, a server, and other appropriate storage media. The storage 1003 may be referred to as “secondary storage apparatus.”

The communication apparatus 1004 is hardware (transmitting/receiving device) for allowing inter-computer communication by using at least one of a wired network and a wireless network, and may be referred to as, for example, a “network device,” a “network controller,” a “network card,” a “communication module” and so on. The communication apparatus 1004 may be configured to include a high frequency switch, a duplexer, a filter, a frequency synthesizer and so on in order to implement, for example, at least one of frequency division duplex (FDD) and time division duplex (TDD). For example, the above-described transmitting/receiving antennas 101 (201), amplifying sections 102 (202), transmitting/receiving sections 103 (203), communication path interface 106 and so on may be implemented by the communication apparatus 1004.

The input apparatus 1005 is an input device for receiving input from the outside (for example, a keyboard, a mouse, a microphone, a switch, a button, a sensor and so on). The output apparatus 1006 is an output device that executes output to the outside (for example, a display, a speaker, an LED (Light Emitting Diode) lamp and so on). Note that the input apparatus 1005 and the output apparatus 1006 may be provided in an integrated structure (for example, a touch panel).

Furthermore, these pieces of apparatus, including the processor 1001, the memory 1002 and so on are connected by the bus 1007 so as to communicate information. The bus 1007 may be formed with a single bus, or may be formed with buses that vary between pieces of apparatus.

Also, the radio base station 10 and the user terminal 20 may be structured to include hardware such as a microprocessor, a digital signal processor (DSP), an ASIC (Application-Specific Integrated Circuit), a PLD (Programmable Logic Device), an FPGA (Field Programmable Gate Array) and so on, and part or all of the functional blocks may be implemented by the hardware. For example, the processor 1001 may be implemented with at least one of these pieces of hardware.

### (Variations)

Note that the terminology used in the present disclosure and the terminology that is needed to understand the present disclosure may be replaced by other terms that convey the same or similar meanings. For example, at least one of “channels” and “symbols” may be replaced by “signals” (or “signaling”). Also, “signals” may be “messages.” A reference signal may be abbreviated as an “RS,” and may be referred to as a “pilot,” a “pilot signal” and so on, depending on which standard applies. Furthermore, a “component carrier (CC)” may be referred to as a “cell,” a “frequency carrier,” a “carrier frequency” and so on.

A radio frame may be comprised of one or more periods (frames) in the time domain. Each of one or more periods (frames) constituting a radio frame may be referred to as a “subframe.” Furthermore, a subframe may be comprised of one or multiple slots in the time domain. A subframe may be a fixed time duration (for example, 1 ms) not dependent on the numerology.

Here, the numerology may be a communication parameter applied to at least one of transmission and reception of a certain signal or channel. The numerology may indicate, for example, at least one of subcarrier spacing (SCS), bandwidth, symbol length, cyclic prefix length, transmission time interval (TTI), number of symbols per TTI, radio frame configuration, specific filtering processing performed by a transceiver in a frequency domain, specific windowing processing performed by a transceiver in a time domain and so on.

A slot may be comprised of one or more symbols in the time domain (OFDM (Orthogonal Frequency Division Multiplexing) symbols, SC-FDMA (Single Carrier Frequency Division Multiple Access) symbols and so on). Also, a slot may be a time unit based on numerology.

A slot may include a plurality of minislots. Each minislot may be comprised of one or more symbols in the time domain. Also, a minislot may be referred to as a “subslot.” Minislots may be composed of fewer symbols than the slot. PDSCH (or PUSCH) transmitted in a time unit larger than the minislots may be referred to as “PDSCH (PUSCH) mapping type A.” PDSCH (or PUSCH) transmitted using the minislots may be referred to as “PDSCH (PUSCH) mapping type B.”

A radio frame, a subframe, a slot, a minislot and a symbol all represent the time unit in signal communication. A radio frame, a subframe, a slot, a minislot and a symbol may be called by other applicable names, respectively.

For example, one subframe may be referred to as a “transmission time interval (TTI),” a plurality of consecutive subframes may be referred to as a “TTI,” or one slot or mini-slot may be referred to as a “TTI.” That is, at least one of a subframe and a TTI may be a subframe (1 ms) in existing LTE, may be a shorter period than 1 ms (for example, one to thirteen symbols), or may be a longer period than 1 ms. Note that the unit to represent the TTI may be referred to as a “slot,” a “mini slot” and so on, instead of a “subframe.”

Here, a TTI refers to the minimum time unit of scheduling in radio communication, for example. For example, in LTE systems, a radio base station schedules the radio resources (such as the frequency bandwidth and transmission power that can be used in each user terminal) to allocate to each user terminal in TTI units. Note that the definition of TTIs is not limited to this.

The TTI may be the transmission time unit of channel-encoded data packets (transport blocks), code blocks, codewords, etc. or may be the unit of processing in scheduling, link adaptation and so on. Note that, when a TTI is given, the period of time (for example, the number of symbols) in which transport blocks, code blocks and/or codewords are actually mapped may be shorter than the TTI.

Note that, when one slot or one minislot is referred to as a “TTI,” one or more TTIs (that is, one or more slots or one or more minislots) may be the minimum time unit of scheduling. Also, the number of slots (the number of minislots) to constitute this minimum time unit of scheduling may be controlled.

A TTI having a time duration of 1 ms may be referred to as a “normal TTI (TTI in LTE Rel. 8 to 12),” a “long TTI,” a “normal subframe,” a “long subframe” and so on. A TTI that is shorter than a normal TTI may be referred to as a “shortened TTI,” a “short TTI,” a “partial TTI” (or a “fractional TTI”), a “shortened subframe,” a “short subframe,” a “mini-slot,” “a sub-slot” and so on.

Note that a long TTI (for example, a normal TTI, a subframe, etc.) may be replaced by a TTI having a time duration exceeding 1 ms, and a short TTI (for example, a shortened TTI) may be replaced by a TTI having a TTI duration less than the TTI duration of a long TTI and not less than 1 ms.

A resource block (RB) is the unit of resource allocation in the time domain and the frequency domain, and may include one or a plurality of consecutive subcarriers in the frequency domain.

Also, an RB may include one or more symbols in the time domain, and may be one slot, one minislot, one subframe or one TTI in length. One TTI and one subframe each may be comprised of one or more resource blocks.

Note that one or more RBs may be referred to as a “physical resource block (PRB (Physical RB)),” a “subcarrier group (SCG),” a “resource element group (REG),” a “PRB pair,” an “RB pair” and so on.

Furthermore, a resource block may be comprised of one or more resource elements (REs). For example, one RE may be a radio resource field of one subcarrier and one symbol.

Note that the structures of radio frames, subframes, slots, minislots, symbols and so on described above are merely examples. For example, configurations pertaining to the number of subframes included in a radio frame, the number of slots per subframe or radio frame, the number of mini-slots included in a slot, the number of symbols and RBs included in a slot or a mini-slot, the number of subcarriers included in an RB, the number of symbols in a TTI, the symbol duration, the length of cyclic prefixes (CPs) and so on can be variously changed.

Also, the information and parameters described in the present disclosure may be represented in absolute values or in relative values with respect to given values, or may be represented using other applicable information. For example, a radio resource may be specified by a given index.

The names used for parameters and so on in the present disclosure are in no respect limiting. For example, since various channels (PUCCH (Physical Uplink Control Channel), PDCCH (Physical Downlink Control Channel) and so on) and information elements can be identified by any suitable names, the various names assigned to these individual channels and information elements are in no respect limiting.

The information, signals and/or others described in the present disclosure may be represented by using any of a variety of different technologies. For example, data, instructions, commands, information, signals, bits, symbols and chips, all of which may be referenced throughout the herein-contained description, may be represented by voltages, currents, electromagnetic waves, magnetic fields or particles, optical fields or photons, or any combination of these.

Also, information, signals and so on may be output at least one of from higher layers to lower layers or from lower layers to higher layers. Information, signals and so on may be input and output via a plurality of network nodes.

The information, signals and so on that are input and/or output may be stored in a specific location (for example, in a memory), or may be managed in a control table. The information, signals and so on to be input and/or output may be overwritten, updated or appended. The information, signals and so on that are output may be deleted. The information, signals and so on that are input may be transmitted to other pieces of apparatus.

Reporting of information is by no means limited to the aspects/embodiments described in the present disclosure, and other methods may be used as well. For example, reporting of information may be implemented by using physical layer signaling (for example, downlink control information (DCI), uplink control information (UCI), higher layer signaling (for example, RRC (Radio Resource Control) signaling, broadcast information (the master information block (MIB), system information block (SIB) and so on), MAC (Medium Access Control) signaling and so on), and other signals and/or combinations of these.

Note that physical layer signaling may be referred to as “L1/L2 (Layer 1/Layer 2) control information (L1/L2 control signals),” “L1 control information (L1 control signal)” and so on. Also, RRC signaling may be referred to as “RRC messages,” and can be, for example, an RRC connection setup message, RRC connection reconfiguration message and so on. Also, MAC signaling may be reported using, for example, MAC control elements (MAC CEs (Control Elements)).

Also, reporting of given information (for example, reporting of information to the effect that “X holds”) does not necessarily have to be sent explicitly, and can be sent implicitly (for example, by not reporting the given information, by reporting other information).

Decisions may be made in values represented by one bit (0 or 1), may be made in Boolean values that represent true or false, or may be made by comparing numerical values (for example, comparison against a given value).

Software, whether referred to as “software,” “firmware,” “middleware,” “microcode” or “hardware description language,” or called by other names, should be interpreted broadly, to mean instructions, instruction sets, code, code segments, program codes, programs, subprograms, software modules, applications, software applications, software packages, routines, subroutines, objects, executable files, execution threads, procedures, functions and so on.

Also, software, commands, information and so on may be transmitted and received via communication media. For example, when software is transmitted from a website, a server or other remote sources by using at least one of wired technologies (coaxial cables, optical fiber cables, twisted-pair cables, digital subscriber lines (DSL) and so on) and wireless technologies (infrared radiation, microwaves and so on), at least one of these wired technologies and wireless technologies are also included in the definition of communication media.

The terms “system” and “network” as used in the present disclosure may be used interchangeably.

In the present disclosure, the terms “base station (BS),” “radio base station,” “fixed station,” “NodeB,” “eNodeB (eNB),” “gNodeB (gNB),” “access point,” “transmission point,” “reception point,” “transmission/reception point,” “cell,” “sector,” “cell group,” “carrier,” “component carrier,” “bandwidth part (BWP)” and so on may be used interchangeably. A base station may be referred to by terms such as a “macro cell,” a “small cell,” a “femto cell,” a “pico cell” and so on.

A base station can accommodate one or more (for example, three) cells (also referred to as “sectors”). When a base station accommodates a plurality of cells, the entire coverage area of the base station can be partitioned into multiple smaller areas, and each smaller area can provide communication services through base station subsystems (for example, indoor small base stations (RRHs (Remote Radio Heads))). The term “cell” or “sector” refers to part or the entirety of the coverage area of at least one of a base station and a base station subsystem that provides communication services within this coverage.

In the present disclosure, the terms “mobile station (MS)” “user terminal,” “user equipment (UE),” “terminal,” etc. may be used interchangeably.

A mobile station may be referred to by terms such as “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client” or some other suitable terms.

At least one of the base station and the mobile station may be referred to as “transmitting apparatus,” “receiving apparatus,” etc. Note that at least one of the base station and the mobile station may be a device mounted on a mobile body, the mobile body itself, or the like. The moving body may be a vehicle (for example, car, airplane, etc.), an unmanned moving body (for example, drone, autonomous vehicle, etc.), or a robot (manned or unmanned). Note that at least one of the base station and the mobile station includes a device that does not necessarily move during a communication operation.

Furthermore, the radio base stations in the present disclosure may be interpreted as user terminals. For example, each aspect/embodiment of the present disclosure may be applied to a configuration in which communication between a radio base station and a user terminal is replaced by communication among a plurality of user terminals (which may be referred to as, for example, D2D (Device-to-Device), V2X (Vehicle-to-Everything) and so on). In this case, user terminals 20 may have the functions of the radio base stations 10 described above. In addition, terms such as “uplink” and “downlink” may be interpreted as a term corresponding to the terminal-to-terminal communication (for example, “side”). For example, an uplink channel and a downlink channel may be interpreted as a side channel.

Likewise, the user terminals in the present disclosure may be interpreted as radio base stations. In this case, the radio base stations 10 may have the functions of the user terminals 20 described above.

Certain actions which have been described in the present disclosure to be performed by base stations may, in some cases, be performed by their upper nodes. In a network comprised of one or more network nodes with base stations, it is clear that various operations that are performed so as to communicate with terminals can be performed by base stations, one or more network nodes (for example, MMEs (Mobility Management Entities), S-GWs (Serving-Gateways) and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts and so on that have been used to describe the aspects/embodiments in the present disclosure may be re-ordered as long as inconsistencies do not arise. For example, although various methods have been illustrated in the present disclosure with various elements of steps in exemplary orders, the specific orders that are illustrated herein are by no means limiting.

The aspects/embodiments illustrated in the present disclosure may be applied to LTE (Long Term Evolution), LTE-A (LTE-Advanced), LTE-B (LTE-Beyond), SUPER 3G, IMT-Advanced, 4G (4th generation mobile communication system), 5G (5th generation mobile communication system), FRA (Future Radio Access), New-RAT (Radio Access Technology), NR(New Radio), NX (New radio access), FX (Future generation radio access), GSM (registered trademark) (Global System for Mobile communications), CDMA 2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark), systems that use other adequate radio communication methods and/or next-generation systems that are enhanced based on these. Further, a plurality of systems may be combined and applied (for example, a combination of LTE or LTE-A and 5G).

The phrase “based on” as used in the present disclosure does not mean “based only on,” unless otherwise specified. In other words, the phrase “based on” means both “based only on” and “based at least on.”

Reference to elements with designations such as “first,” “second” and so on as used in the present disclosure does not generally limit the number/quantity or order of these elements. These designations may be used in the present disclosure only for convenience, as a method for distinguishing between two or more elements. In this way, reference to the first and second elements does not imply that only two elements may be employed, or that the first element must precede the second element in some way.

The terms “judge (determine)” as used in the present disclosure may encompass a wide variety of actions. For example, to “judge (determine)” as used herein may be interpreted to mean making judgements (determinations) related to judging, calculating, computing, processing, deriving, investigating, looking up (for example, searching a table, a database or some other data structure), ascertaining and so on.

Furthermore, to “judge (determine)” as used herein may be interpreted to mean making judgements (determinations) related to receiving (for example, receiving information), transmitting (for example, transmitting information), inputting, outputting, accessing (for example, accessing data in a memory) and so on.

In addition, to “judge (determine)” as used herein may be interpreted to mean making judgements (determinations) related to resolving, selecting, choosing, establishing, comparing and so on. In other words, to “judge (determine)” as used herein may be interpreted to mean making judgements (determinations) related to some action.

In addition, to “judge (determine)” as used herein may be interpreted as “assuming,” “expecting,” “considering,” or the like.

The “maximum transmission power” described in the present disclosure may mean the maximum value of the transmission power, the nominal maximum transmission power (nominal UE maximum transmit power), or the rated maximum transmission power (rated UE maximum transmit power).

As used in the present disclosure, the terms “connected” and “coupled,” or any variation of these terms, mean all direct or indirect connections or coupling between two or more elements, and may include the presence of one or more intermediate elements between two elements that are “connected” or “coupled” to each other. The coupling or connection between the elements may be physical, logical or a combination of these. For example, “connection” may be interpreted as “access.”

As used in the present disclosure, when two elements are connected, these elements may be considered “connected” or “coupled” to each other by using at least one electrical wire, cable, printed electrical connection, or the like, and, as a number of non-limiting and non-inclusive examples, by using electromagnetic energy, such as electromagnetic energy having wavelengths in the radio frequency, microwave and optical (both visible and invisible) regions.

In the present disclosure, the phrase “A and B are different” may mean “A and B are different from each other.” The terms such as “leave” “coupled” and the like may be interpreted as well.

When terms such as “include,” “including” and variations of these are used in the present disclosure, these terms are intended to be inclusive, in a manner similar to the way the term “comprising” is used. Furthermore, the term “or” as used in the present disclosure is intended to be not an exclusive disjunction.

In the present disclosure, where articles, such as “a,” “an,” and “the” in English are added by translations, the present disclosure may include that the noun that follows these articles is in the plural.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description in the present disclosure is provided only for the purpose of explaining examples, and should by no means be construed to limit the invention according to the present disclosure in any way.

This application is based on Japanese Patent Application No. 2018-092586 filed on Apr. 20, 2018. All of this content is included here.

1. A user terminal comprising:
a receiving section that receives at least one of a transmission request signal and a receivable signal according to a second radio communication standard in a carrier that applies listening to transmission of a first radio communication standard; and
a control section that controls the listening based on a time parameter indicated in at least one of the transmission request signal and the receivable signal.

2. The user terminal according to claim 1, wherein, when the receiving section receives the receivable signal, the control section controls the listening after an elapse of time based on the time parameter from the reception of the receivable signal.

3. The user terminal according to claim 1, wherein, when the receiving section does not receive the receivable signal in a given period after reception of the transmission request signal, the control section controls the listening based on monitoring of a transmission signal from a transmission source of the transmission request signal.

4. The user terminal according to claim 3, wherein, when the transmission signal is detected by the monitoring, the control section controls the listening after the elapse of time based on the time parameter from the reception of the transmission request signal.

5. The user terminal according to claim 3, wherein, when the transmission signal is not detected by the monitoring, the control section controls the listening immediately.

6. A radio base station comprising:
a receiving section that receives at least one of a transmission request signal and a receivable signal according to a second radio communication standard in a carrier that applies listening to transmission of a first radio communication standard; and
a control section that controls the listening based on a time parameter indicated in the transmission request signal and the receivable signal.

7. The user terminal according to claim 2, wherein, when the receiving section does not receive the receivable signal in a given period after reception of the transmission request signal, the control section controls the listening based on monitoring of a transmission signal from a transmission source of the transmission request signal.
